(19) United States
(12) Patent Application Publication
(10) Pub. No.: US 2019/0274071 A1
(43) Pub. Date: Sep. 5, 2019

(54) ENHANCED REACTIVATION FOR LIGHT CONNECTION

(71) Applicant: NOKIA TECHNOLOGIES OY, Espoo (FI)

(72) Inventors: Ilkka Keskitalo, Oulu (FI); Petteri Lunden, Espoo (FI); Elena Virtej, Espoo (FI)

(21) Appl. No.: 16/346,541

(22) PCT Filed: Nov. 2, 2016
(86) PCT No.: PCT/FI2016/050766

§ 371 Date: May 1, 2019

(51) Int. Cl. H04W 36/00; H04L 29/08; H04W 76/27

(52) U.S. Cl. CPC H04W 36/0033; H04W 76/27; H04L 29/08

(57) ABSTRACT

Various communication systems may benefit from mechanism for enhancing communications. For example, certain wireless communication systems may benefit from enhanced reactivation for light connected user equipment. A method can include preparing a message to be sent to a user equipment. The message can be configured to command the user equipment to enter light connection mode. The method can also include including, in the message with the command to enter light connection mode, an indication of at least one carrier or secondary cell.

### BACKGROUND

### Field

Various communication systems may benefit from mechanism for enhancing communications. For example, certain wireless communication systems may benefit from enhanced reactivation for light connected user equipment.

### Description of the Related Art

Third generation partnership project (3GPP) has a work item (WI) “Signalling reduction to enable light connection for LTE” (RP-160937). The WI focuses on reduction of signaling both over the radio interface and between network nodes. Also, the WI focuses on minimization of latencies and user equipment (UE) power consumption for all device types. Similar functionality may be defined for fifth generation (5G) New Radio (NR). Currently the new mode is called CONNECTED-INACTIVE.

Light connection (LC) may allow UE centric mobility, in which the UE without active data transmission may be moved to lightly connected mode in which the context is stored both at the UE and in RAN, in the serving or “anchor” evolved Node B (eNB). Mobility is based on cell re-selections instead of handovers like in normal connected mode. The LC mode is limited to a certain area, indicated by a number of cells, specific LC area identifier (ID) or tracking area (TA). Re-selections are allowed within this area without notifying the network (NW) about the cell changes. When the UE re-selects a cell belonging to another LC area, it indicates to the NW, specifically to the RAN, about the UE's new location.

LC operation may be suitable and beneficial for intermittent and bursty data transmission where both mobility, such as handover (HO), and state transition signaling can be minimized. At the same time the latency to resume the data transfer can be minimized due to lighter signaling procedure and avoidance of the core network (CN) involvement. LC is limited to RAN and UE and hence hidden from the CN.

The definitions and assumptions for LC operation so far have focused on resumption of the connection for a primary cell (PCell). It is assumed that the CA configuration is not valid during the LC mode.

### SUMMARY

According to a first embodiment, a method can include preparing a message to be sent to a user equipment. The message can be configured to command the user equipment to enter light connection mode. The method can also include including, in the message with the command to enter light connection mode, an indication of at least one carrier or secondary cell.

According to a second embodiment, a method can include receiving, by a user equipment, a message configured to command the user equipment to enter light connection mode. The message can include with the command to enter light connection mode, an indication of at least one carrier or secondary cell. The method can also include entering light connected mode based on the message.

According to third and fourth embodiments, an apparatus can include means for performing a process. The process can include the method respectively according to the first or second embodiment.

According to fifth and sixth embodiments, an apparatus can include at least one processor and at least one memory including computer program code. The at least one memory and the computer program code can be configured to, with the at least one processor, at least to perform a process. The process can include the method respectively according to the first or second embodiment.

According to seventh and eighth embodiments, a computer program product can encode instructions for performing a process. The process can include the method respectively according to the first or second embodiment.

According to ninth and tenth embodiments, a non-transitory computer-readable medium can be encoded with instructions that, when executed in hardware, perform a process. The process can include the method respectively according to the first or second embodiment.

According to eleventh and twelfth embodiments, a system can include an apparatus according to the third or fifth embodiments in communication with an apparatus according to the fourth or sixth embodiments, respectively.

### BRIEF DESCRIPTION OF THE DRAWINGS:

For proper understanding of the invention, reference should be made to the accompanying drawings, wherein:

FIG. 1 illustrates the basic operation of the light connection, where the continued connection is triggered by the arrival of MT data.

FIG. 2 illustrates a signalling for a mobile originated call with a same cell/eNB, according to certain embodiments.

FIG. 3 illustrates a signalling for a mobile originated call with a new cell/new eNB, according to certain embodiments.

FIG. 4 illustrates a signalling for a mobile terminated call with a same cell/eNB, according to certain embodiments.

FIG. 5 illustrates a signalling for a mobile terminated call with a new cell/new eNB, according to certain embodiments.

FIG. 6 illustrates a method according to certain embodiments.

FIG. 7 illustrates a system according to certain embodiments.

### DETAILED DESCRIPTION:

Certain embodiments provide signaling procedures to be used to (re-)initiate mobile originated (MO) and mobile terminated (MT) data transmissions while in LC mode. For MO data, the UE may re-activate the connection, for example either by a connection resume request message, if the connection was suspended with a similar procedure to a narrow band Internet of things (NB-IOT) case, or initiating connection re-establishment procedure. It has been agreed that the MT data triggers paging when arriving to the anchor (old serving) eNB. Subject to final agreement on the support for multi-eNB LC (or paging) area, the anchor eNB may or may not distribute paging over the X2 interface to cells/eNBs belonging to the LC area.

Previously, no specific measurements have been defined for LC mode help in (re)-configuring the new active connection to reflect the radio conditions.

The enhancing the utilization of carrier aggregation may take into account that a carrier aggregation (CA) is released when the UE goes to idle. This may slow subsequent setup of the CA, due to increased delay in measurements, measurement reporting. Certain embodiments speed up restoration of a multi-connectivity service to UE, such as carrier aggregation, when UE changes from LC (or radio resource control (RRC)-inactive in NR) mode to connected or active mode either based on mobile originated or mobile terminated data transmission. Hence the user experience can be improved in certain embodiments. Certain embodiments can also contribute to providing a certain or predefined guaranteed quality of service to a user as well as reducing signaling required for (re-)configurations.

Certain embodiments define procedure and signaling for a situation in which light connection (LC) mode can support CA (re-)configuration, dual-connectivity (DC) or multi-connectivity (re-)configuration. More particularly, certain embodiments may minimize the latencies for connection setup and improving the user perceived throughput (UPT). The procedures can include the procedures discussed below. In the following discussion, some alternative options exist, and not all the steps mentioned are mandatory.

Some example embodiments are described in the context of carrier aggregation. It is used here as non-restrictive example case, and the examples could be applied to dual connectivity or multi-connectivity as well. These all are examples of a more general case where the UE is connected to or served by multiple cells at once. A typical use case is that UE has a connection to macro cell that offers wide area coverage and an anchor point for the mobility. Then in order to provide higher throughput connection, the UE is configured with a small cell that is under the macro cell coverage. Depending on the deployment and e.g. the backhaul connection between the eNBs (base stations) operating these cells, the small cell could be configured to the UE e.g. as a secondary cell (or multiple cells on different carriers) in carrier aggregation way if the backhaul connection is ideal or as a secondary eNB in dual connectivity if there notable backhaul delay. Multi-connectivity or LTE-5G interworking could apply also e.g. in case one of the cells is an LTE cell and another one is a 5G New Radio (NR) cell. Otherwise, LTE cell could be also aggregated with WLAN technology. Certain embodiments generally apply to these different ways of aggregating spectrum/carriers and/or cells of same or different radio access technologies.

A UE can be in connected mode and can have multi-connectivity, such as CA, configured. The multi-connectivity configuration may not be active, such as in case of carrier aggregation. When there is a break in data transmission, the network (NW), such as an access point of the radio access network, may decide to move the UE to LC mode. Alternatively, or in addition, the UE could determine and/or request LC mode. Existing CA configuration/multi-connectivity/dual-connectivity may or may not be stored as part of the context in LC mode. The context may be stored at the UE and/or the NW.

In certain embodiments, various characteristics of a previous carrier aggregation, such as carriers/secondary cells (SCells) of the previous CA configuration, or those relevant for the cells of the LC area, can be indicated in the command to the UE to enter the LC mode. The CA configuration, or carrier list, can be kept stored. As mentioned above, this can be kept stored in the UE and/or a network element of the radio access network.

The identified secondary cells can be those relevant for the LC area or RAN paging area where the LC mode is valid. Light connection operation may only be valid in a limited area, called LC (or RAN paging) area where the UE is allowed to move without indicating the UE's own location to the network. The LC area can cover a number of cells and physically the area can be smaller than the tracking areas (TA) used in typical LTE deployments. As the cells may be neighboring cells (not necessary all the neighboring cells), the cells of the LC area may have similar site configurations and the CA configuration could be similar.

An example may be a small cell cluster in, for example an office building, shopping mall, campus area or the like, where UEs may move between cells. During LC mode, the UE can measure the SCells/carriers indicated by the NW. This may be in contrast to simply carrying out neighbor cell measurements when in idle mode without consideration of such indicated SCells/carriers. The UE can measure reference signal received power (RSRP), received signal strength indicator (RSSI), and reference signal received quality (RSRQ).

The UE may carry out cell reselections while measuring the indicated SCells/carriers. This may contrast to merely carrying out cell reselection for example when the serving cell radio frequency (RF) carrier strength is poor or when a suitable high strength neighbor cell is available. Cell reselection is, for example, a defined procedure in LTE.

Re-selections may be done for the PCell but not excluding UE internal reselections of SCells. Both the PCell reselections and SCell reselections can be reported to the NW along with the measurement results.

The UE may measure a subset of the carriers indicated by the NW. The UE, for example, may not measure all the SCells/carriers but for example only one representative or a few representative SCell(s)/carrier(s).

One option is that the UE can measure the carrier that had the strongest SCell when the UE was last in connected mode. The measured carriers/SCells can be either those indicated in the suspend command (optional) or those of the previous CA configuration. Any combination of the two is possible. The mobility in LC mode can be based on re-selections similar to IDLE mode where the UE is interested in the candidates for a serving PCell only.

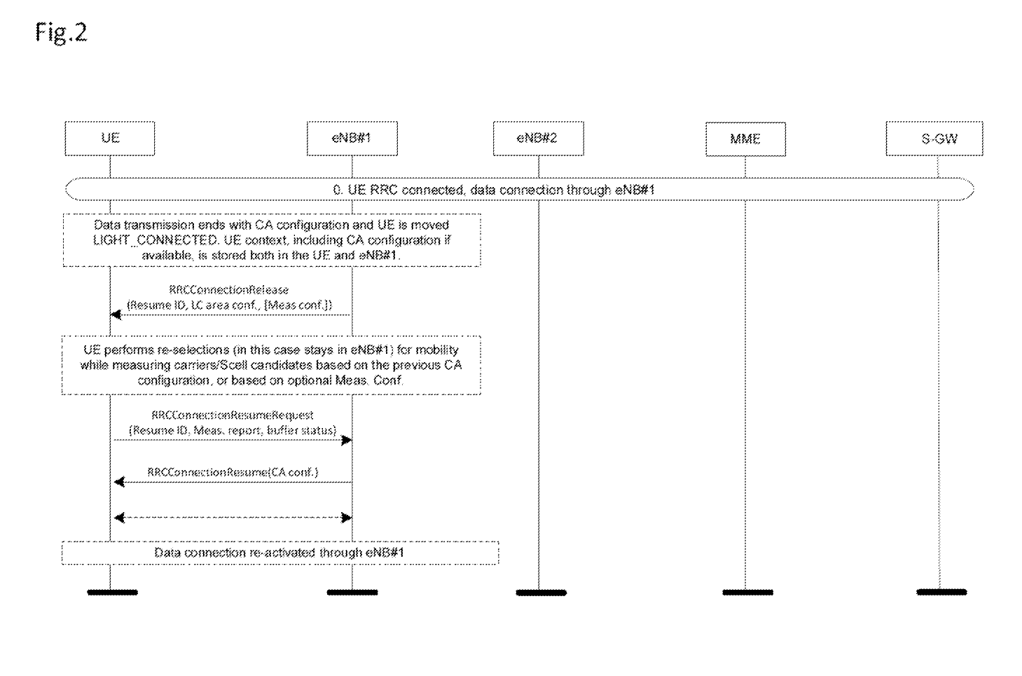

The above features can relate to a situation prior to beginning to resume the connection. When the connection is resumed, the UE can signal the measurement results. The measurement results can be included in a defined message from the UE when resuming the connection, or in a paging response for MT data. FIGS. 2 through 5, discussed below, provide some further illustration in this regard. Monitoring paging channel and transmitting paging response can be part of an RRC connection re-establishment. The UE can carry out an SCell reselection when in LC mode and may signal the results to the NW when the resuming the connection takes place, for example in a RRCConnectionResumeRequest, as a proposal or assistance for the new CA configuration.

The UE may include, in the report, the buffer status of potential MO data to assist the eNB for possible CA configuration. For example, this buffer status may help the eNB or other access node to identify the number of carriers needed for MO data.

In addition to the measurement results, the previous CA configuration may be signaled to the eNB in both MT/MO calls or data transfers. In the case of MT data transfer, the eNB may request the CA configuration for the UE as a part of the paging procedure. This request may be sent in the case that the eNB has not stored the configuration or as a precaution, for example the UE may have been in LC mode for quite a long time and the stored information may have expired. The eNB may rely on a validity timer to make this assessment. The CA configuration may also be a mandatory information in the resume request, for example if CA was configured during the previous active connection. If the UE has carried out an SCell reselection during LC mode, for example the UE is camping on a cell different from the previous serving cell, the UE may send the CA configuration as a proposal in a connection resume request. When the cell is outside the configured LC area, the UE can send an indication to the NW regardless of whether there is data to be transmitted or not.

Based on the cell configuration, load situation, and reported measurement results, the radio access network (RAN) can select suitable SCells to be used for the resumed connection. Due to UE movement or other changes in the environment, radio propagation towards the cells may change and not all SCells from the previous CA configuration may have sufficient connection quality. The UE reported results may thus help in deciding upon the new configuration. Furthermore, not all site configurations are identical. Thus, the supported carriers may vary, which means that some SCells may not be supported or some new ones could be available in a new location to which the UE might have moved during the LC mode.

If the connection is resumed in the old serving cell and thus PCell has not been changed, the previous CA configuration may be activated. Nevertheless, the other inputs including, for example, the status of the data buffer, cell load, and so on, may be used to adapt to a new data connection.

For MO data, the UE may indicate the buffer status in addition to measurement results, in order to provide sufficient information for the CA configuration. For MT data, the RAN itself may decide upon the CA configuration, possibly utilizing the information from the UE. The NW may, for example, know the amount of data and hence may be able to determine the required radio resource allocation for the resumed connection.

The resumed connection can be initiated by paging. The paging response from the UE can include measurement results for cells of the configured CA. The RAN can indicate the selected CA configuration in the resume signaling. It may be a configuration made by eNB or an ACK to a configuration indicated by the UE, such as a cell reselection carried out during LC mode. Also, in this case the NW, for example eNB, can decide on the CA configuration to be used.

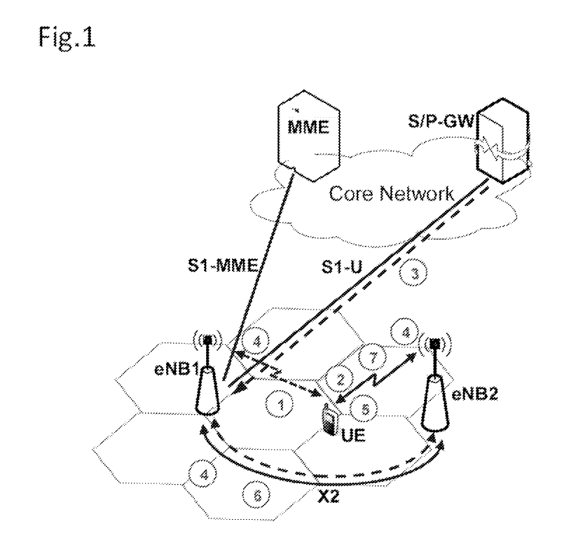

FIG. 1 illustrates the basic operation of the light connection, where the continued connection is triggered by the arrival of MT data. As shown in FIG. 1, at 1 the UE can be connected to eNB1, possibly configured for CA. Data transmission can end and the UE can move to LC-mode. The UE context can be stored both in eNB1 and UE. The stored context can include the CA configuration

UE autonomous and/or UE centric mobility can be allowed. This can include mobility with re-selections within the LC area. The LC area can be indicated with dedicated signaling when moving into the LC mode.

In this case, eNB1 can become an anchor eNB maintaining an S1 connection to the CN. In certain embodiments, the CN may not be informed about the UE LC mode. The UE can monitor paging with configured discontinuous reception (DRX) for a paging monitoring cycle, which can be the default paging cycle or can be UE specific and/or RAN specific.

At 2, the UE in LC can re-select another cell within the LC area. In this case, the re-selected-to cell is under eNB2. Because an LC or paging area update is only done when moving beyond a current LC area, there is no need for the UE to perform a cell update at 2. The LC area may be limited to cells of a single eNB, or can extend to cells of multiple eNBs.

At 3, MT data can arrive from the CN to eNB1. The CN can treat the situation as being that the UE was normally connected. As mentioned above, LC can be transparent to the CN. Thus, the CN may not know that the UE is not normally connected.

At 4, eNB1 can initiate paging transmission within the LC area triggered by MT data. X2 signaling can be used if inter-eNB paging is allowed. The paging message may indicate if the UE should send the latest measurement report in the paging response as assistance information for possible CA configuration.

At 5, the UE can send the paging response to eNB2. A measurement report can be included autonomously by the UE or by request from the eNB.

At 6, context can be fetched from the anchor cell (eNB1) to eNB2. The user plane (UP) path may be routed via the anchor eNB1 or normal S1-U path switch.

At 7, there can be connection re-configuration. In this stage, eNB2 may configure the resumed connection, taking into account the measurement report, data amount (which may already be known for MT data), stored and retrieved CA configuration (from the anchor eNB), cell load, or other relevant information. Any combination of these may be used by eNB2.

FIG. 2 through 5 show examples of the signaling flows for MO call in the same or new cell, and MT call in the same or new cell, respectively. These figures illustrate extended signaling to provide potential measurement configuration, and to report the measurement results done during the LC mode. The carrier aggregation configuration done after connection resumption can utilize reported results as well as possible data buffer size indication from the UE for example in the case of an MO call, among other relevant information the eNB may have. The measurement configuration at the entrance of LC mode can be optional and the measurements can be based on the previous CA configuration. Alternatively, the measurements can be done based on the combination of CA configuration and the signaled measurement configuration.

The applicability of certain embodiments is not limited to the exemplary signaling flows in FIGS. 2 through 5 but can also include suitable variations for both MO and MT calls.

FIG. 2 illustrates a signalling for a mobile originated call with a same cell/eNB, according to certain embodiments. As shown in FIG. 2, a UE can initially be RRC connected with a data connection through eNB#1. At 210, data transmission can end with a particular CA configuration and the UE can be moved to light connected mode. The UE context, including CA configuration if available, can be stored both in the UE and in eNB#1.

At 220, eNB#1 can send an RRC connection release message to the UE. This release message can include a variety of information include a resume ID, an LC area configuration, and a measurement configuration.

At 230, the UE can perform re-selections (in this case, the UE either stays with or returns eventually to eNB#1). The re-selections can be for mobility while measuring carriers/SCell candidates based on the previous CA configuration or based on optional measurement configuration.

At 240, the UE can send an RRC connection resume request. The request can include a resume ID, measurement reports, and buffer status information. At 250, eNB#1 can respond with an RRC connection resume message, including CA configuration information to be used in the resumed connection. Then, at 260, data transfer can occur, and at 470 a data connection can be re-activated through eNB #1.

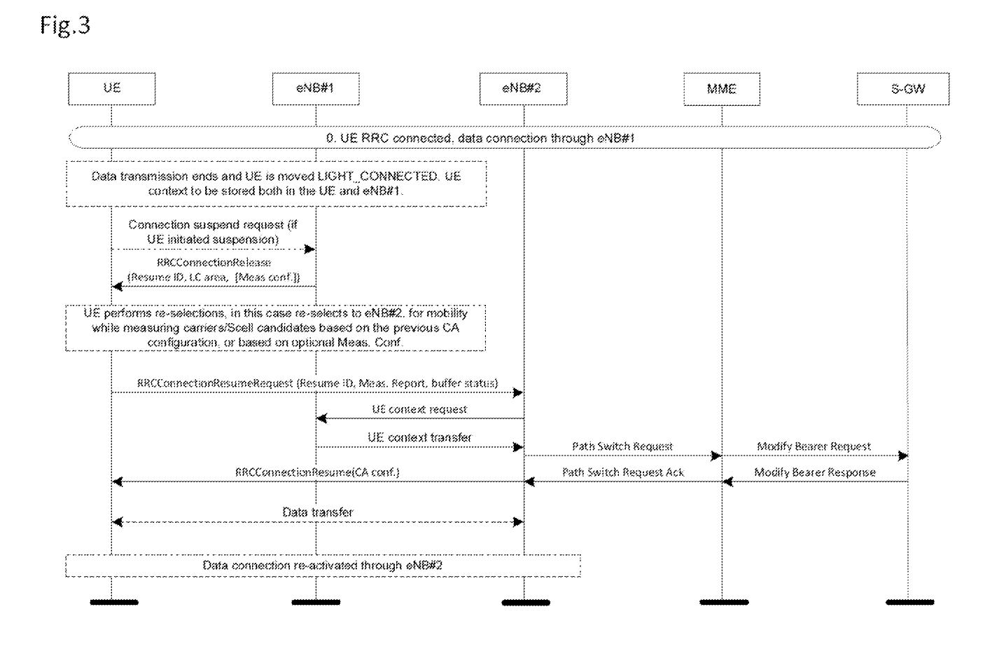

FIG. 3 illustrates a signalling for a mobile originated call with a new cell/ new eNB, according to certain embodiments. At 310, data transmission can end with a particular CA configuration and the UE can be moved to light connected mode. The UE context, including CA configuration if available, can be stored both in the UE and in eNB#1.

At 315, the UE can send a connection suspend request, if the UE initiates suspension. At 320, eNB#1 can send an RRC connection release message to the UE. This release message can include a variety of information include a resume ID, an LC area configuration, and a measurement configuration.

At 325, the UE can perform re-selection (in this case, the UE res-selects to eNB#2). The re-selections can be for mobility while measuring carriers/SCell candidates based on the previous CA configuration or based on optional measurement configuration.

At 330, the UE can send an RRC connection resume request to eNB#2. The request can include a resume ID, measurement reports, and buffer status information. At 335, eNB#2 can send a UE context request to eNB#1. At 340, eNB#1 can transfer UE context to eNB#2, and eNB#2 can send a path switch request to a mobility management entity (MME), which can in turn send a modify bearer request to a serving gateway (S-GW).

At 345, eNB#2 can respond with an RRC connection resume message after obtaining a path switch request acknowledgment from a mobility management entity based on the mobility management entity receiving a modified bearer response from the serving gateway. The resume message can include CA configuration information to be used in the resumed connection. Data transfer can occur at 350, and at 355 a data connection can be re-activated through eNB #2.

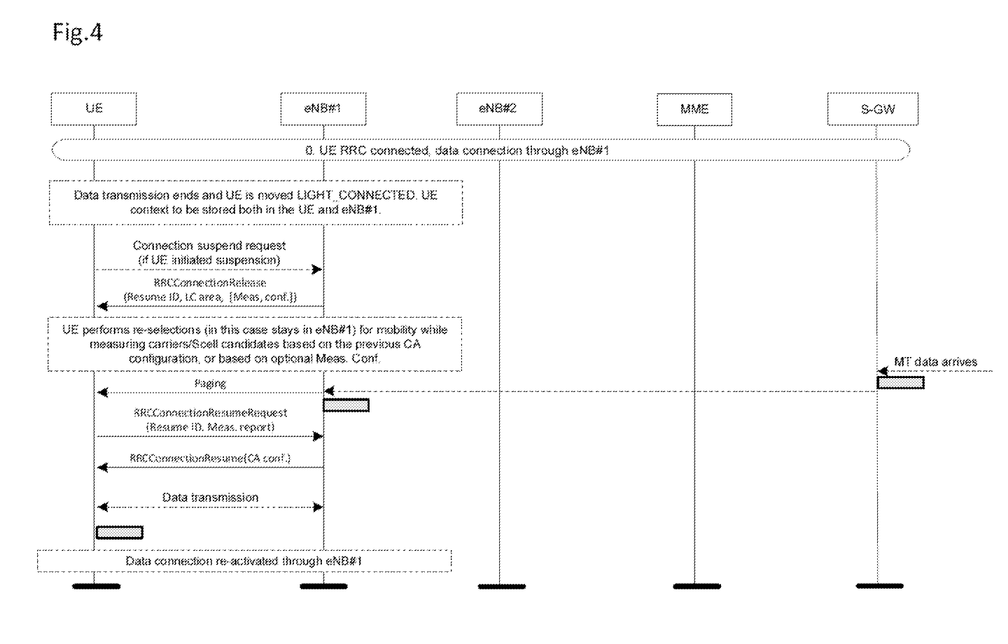

FIG. 4 illustrates a signalling for a mobile terminated call with a same cell/eNB, according to certain embodiments. At 410, data transmission can end with a particular CA configuration and the UE can be moved to light connected mode. The UE context, including CA configuration if available, can be stored both in the UE and in eNB#1.

At 415, the UE can send a connection suspend request, if the UE initiates suspension. At 420, eNB#1 can send an RRC connection release message to the UE. This release message can include a variety of information include a resume ID, an LC area configuration, and a measurement configuration.

At 425, the UE can perform re-selection (in this case, the UE stays or returns to eNB#1). The re-selections can be for mobility while measuring carriers/SCell candidates based on the previous CA configuration or based on optional measurement configuration.

At 430, MT data can arrive at the serving gateway. The serving gateway can notify eNB#1, which can page the UE at 435.

At 440, the UE can send an RRC connection resume request. The request can include a resume ID, measurement reports, and buffer status information. At 445, eNB#1 can respond with an RRC connection resume message, including CA configuration information to be used in the resumed connection. Data transmission can occur at 450 and at 455, a data connection can be re-activated through eNB #1.

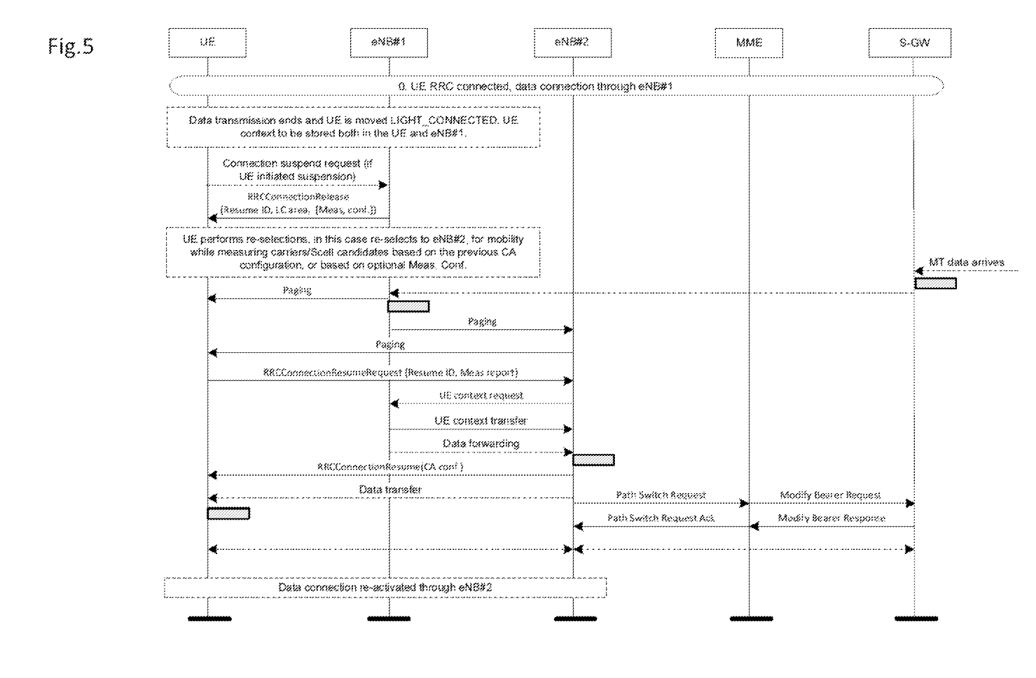

FIG. 5 illustrates a signalling for a mobile terminated call with a new cell/new eNB, according to certain embodiments. At 510, data transmission can end with a particular CA configuration and the UE can be moved to light connected mode. The UE context, including CA configuration if available, can be stored both in the UE and in eNB#1.

At 515, the UE can send a connection suspend request, if the UE initiates suspension.

At 520, eNB#1 can send an RRC connection release message to the UE. This release message can include a variety of information include a resume ID, an LC area configuration, and a measurement configuration.

At 525, the UE can perform re-selection (in this case, the UE re-selects to eNB#2). The re-selections can be for mobility while measuring carriers/SCell candidates based on the previous CA configuration or based on optional measurement configuration.

At 530, MT data can arrive at the serving gateway. The serving gateway can notify eNB#1, which can page the UE and eNB#2 at 535. At 540, eNB#2 can page the UE.

At 545, the UE can send an RRC connection resume request to eNB#2. The request can include a resume ID and measurement reports. At 550, eNB#2 can send a UE context request to eNB#1. At 550, eNB#1 can transfer UE context to eNB#2. At 560, eNB#1 can forward data to be sent to the UE to eNB#2.

At 565, eNB#2 can respond to the UE with an RRC connection resume message. The resume message can include CA configuration information to be used in the resumed connection. Then, at 570, eNB#2 can forward the previously forwarded data to the UE and can send a path switch request to a mobility management entity (MME), which can in turn send a modify bearer request to a serving gateway (S-GW).

At 575, eNB#2 can obtain a path switch request acknowledgment from a mobility management entity based on the mobility management entity receiving a modified bearer response from the serving gateway. Data transfer can occur at 580, and at 585 a data connection can be re-activated through eNB #2.

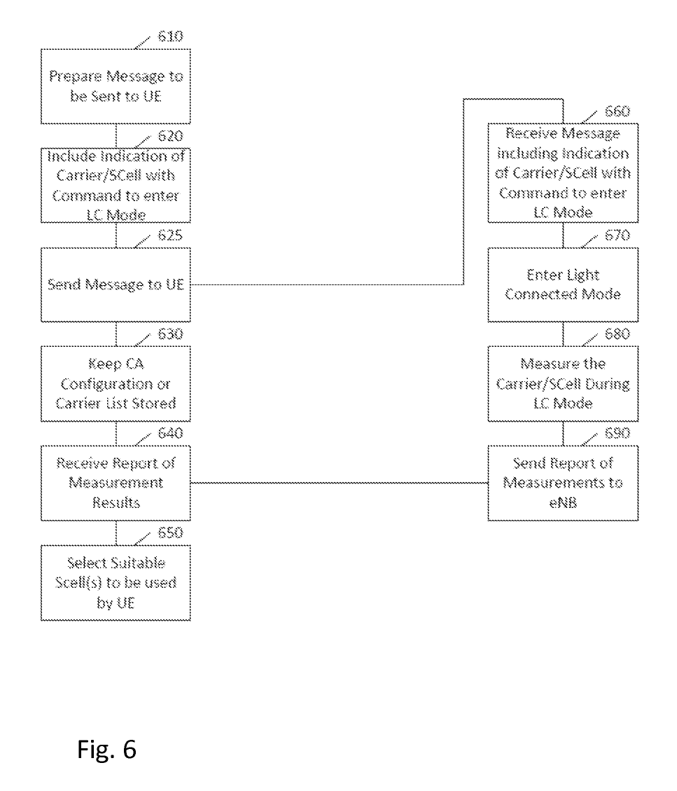

FIG. 6 illustrates a method according to certain embodiments. The method of FIG. 6 may implement or be used in combination with the signalling flows illustrated in FIGS. 2 through 5. Moreover, the architecture shown in FIG. 1 can be applied in any of these embodiments. The approach of FIG. 6 may also be used in combination with any other embodiments disclosed herein. As shown in FIG. 6, a method can include, at 610, preparing a message to be sent to a user equipment. The message can be configured to command the user equipment to enter light connection mode.

The method can also include, at 620, including, in the message with the command to enter light connection mode, an indication of at least one carrier or secondary cell. The indication can include an indication of the at least one carrier or the secondary cell used in a previous carrier aggregation configuration or relevant for cells of a light connection area.

The message can be sent at 625.

In an example embodiment, the indication can be any kind of information, either list of carriers or just a flag indicating the UE to measure the SCells of the previous CA configuration. In an example embodiment, the indication can include information or configuration related to CA or SCell operation, for example a list of carriers or a flag indicating the UE to measure the SCells of the previous CA configuration.

The method can further include, at 630, keeping a carrier aggregation configuration or carrier list stored after the message is sent to the user equipment. The indication can be configured to trigger the user equipment to measure the at least one carrier or the secondary cell during light connected mode.

The method can further include, at 640, receiving, from the user equipment, a report comprises measurement results responsive to the indication included with the command. The report can be received after a connection is resumed following the light connection mode or in a paging response for mobile terminated data. The report can further include a buffer status of potential mobile originated data.

The method can additionally include, at 650, selecting, based on the report, at least one suitable secondary cell to be used by the user equipment for a resumed connection.

The above features of the method may be performed by a network element, such as any access node, such as a base station or eNB. For example, these features may be performed by eNB#1 or eNB#2 in FIGS. 2 through 5. The following features of the method may be performed by, for example, a user equipment such as UE in FIGS. 2 through 5.

The method can include, at 660, receiving, by a user equipment, a message configured to command the user equipment to enter light connection mode. The message can include with the command to enter light connection mode, an indication of at least one carrier or secondary cell. This can be the same message sent at 625. The indication can include an indication of the at least one carrier or the secondary cell used in a previous carrier aggregation configuration or relevant for cells of a light connection area, as mentioned above. The method can also include, at 670, entering light connected mode based on the message.

The method can further include, at 680, measuring the at least one carrier or the secondary cell during light connected mode based on the indication.

The method can additionally include, at 690, sending a report of the measurements of the at least one carrier or the secondary cell. The report can be responsive to the indication included with the command. This can be the same report received at 640. The report can be sent after a connection is resumed following the light connection mode or in a paging response for mobile terminated data. The report can further include a buffer status of potential mobile originated data.

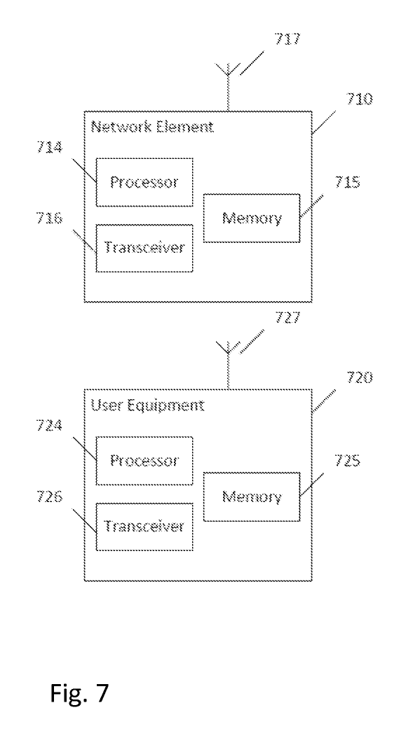

FIG. 7 illustrates a system according to certain embodiments of the invention. It should be understood that each block of the flowchart of FIG. 6 may be implemented by various means or their combinations, such as hardware, software, firmware, one or more processors and/or circuitry. In one embodiment, a system may include several devices, such as, for example, network element 710 and user equipment (UE) or user device 720. The system may include more than one UE 720 and more than one network element 710, although only one of each is shown for the purposes of illustration. A network element can be an access point, a base station, an eNode B (eNB), or any other network element, such as a PCell base station or an SCell base station.

Each of these devices may include at least one processor or control unit or module, respectively indicated as 714 and 724. At least one memory may be provided in each device, and indicated as 715 and 725, respectively. The memory may include computer program instructions or computer code contained therein, for example for carrying out the embodiments described above. One or more transceiver 716 and 726 may be provided, and each device may also include an antenna, respectively illustrated as 717 and 727. Although only one antenna each is shown, many antennas and multiple antenna elements may be provided to each of the devices. Other configurations of these devices, for example, may be provided. For example, network element 710 and UE 720 may be additionally configured for wired communication, in addition to wireless communication, and in such a case antennas 717 and 727 may illustrate any form of communication hardware, without being limited to merely an antenna.

Transceivers 716 and 726 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 720 may be a mobile station (MS) such as a mobile phone or smart phone or multimedia device, a computer, such as a tablet, provided with wireless communication capabilities, personal data or digital assistant (PDA) provided with wireless communication capabilities, vehicle, portable media player, digital camera, pocket video camera, navigation unit provided with wireless communication capabilities or any combinations thereof The user device or user equipment 720 may be a sensor or smart meter, or other device that may usually be configured for a single location.

In an exemplifying embodiment, an apparatus, such as a node or user device, may include means for carrying out embodiments described above in relation to FIG. 6.

Processors 714 and 724 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof The term circuitry may refer to one or more electric or electronic circuits. The term processor may refer to circuitry, such as logic circuitry, that responds to and processes instructions that drive a computer.

For firmware or software, the implementation may include modules or units of at least one chip set (e.g., procedures, functions, and so on). Memories 715 and 725 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 710 and/or UE 720, to perform any of the processes described above (see, for example, FIG. 6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 7 illustrates a system including a network element 710 and a UE 720, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

CA Carrier Aggregation
CN Core Network
eNB Enhanced NodeB
LC Light Connection
MME Mobility Management Entity, a CN node
MO Mobile Originated
MT Mobile Terminated
NAS Non-Access Stratum
NR New (5G) Radio
NW Network
PCell Primary Cell
RRC Radio resource control
SCell Secondary Cell
UE User Equipment
Uu Radio interface between UE and eNB
   A method, comprising:
   preparing a message to be sent to a user equipment, wherein the message is configured to command the user equipment to enter light connection mode; and
   including, in the message with the command to enter light connection mode, an indication of at least one carrier or secondary cell.

2. The method of claim 1, wherein the indication comprises an indication of the at least one carrier or the secondary cell used in a previous carrier aggregation configuration.

3. The method of claim 1, wherein the indication comprises an indication of the at least one carrier or the secondary cell relevant for cells of a light connection area.

4. The method of claim 1, further comprising:
keeping a carrier aggregation configuration or carrier list stored after the message is sent to the user equipment.

5. The method of claim 1, wherein the indication is configured to trigger the user equipment to measure the at least one carrier or the secondary cell during light connected mode.

6. The method of claim 1, further comprising:
receiving, from the user equipment, a report comprises measurement results responsive to the indication included with the command.

7. The method of claim 6, wherein the report is received after a connection is resumed following the light connection mode.

8. The method of claim 6, wherein the report is received in a paging response for mobile terminated data.

9. The method of claim 6, wherein the report further comprises a buffer status of potential mobile originated data.

10. The method of claim 6, further comprising:
selecting, based on the report, at least one suitable secondary cell to be used by the user equipment for a resumed connection.

11. A method, comprising:
receiving, by a user equipment, a message configured to command the user equipment to enter light connection mode, wherein the message comprises with the command to enter light connection mode, an indication of at least one carrier or secondary cell; and
entering light connected mode based on the message.

12. The method of claim 11, wherein the indication comprises an indication of the at least one carrier or the secondary cell used in a previous carrier aggregation configuration.

13. The method of claim 11, wherein the indication comprises an indication of the at least one carrier or the secondary cell relevant for cells of a light connection area.

14. The method of claim 11, further comprising:
measuring the at least one carrier or the secondary cell during light connected mode based on the indication.

15. The method of claim 14, further comprising:
sending a report of the measurements of the at least one carrier or the secondary cell, wherein the report is responsive to the indication included with the command.

16. The method of claim 15, wherein the report is sent after a connection is resumed following the light connection mode.

17. The method of claim 15, wherein the report is sent in a paging response for mobile terminated data.

18. The method of claim 15, wherein the report further comprises a buffer status of potential mobile originated data.

19. (canceled)

20. An apparatus, comprising:
at least one processor; and
at least one memory including computer program code,
wherein the at least one memory and the computer program code are configured to, with the at least one processor, at least to perform a process, the process comprising the method according to claim 1.

21. A computer program product encoding instructions for performing a process, the process comprising the method according to claim 1.

22. A non-transitory computer-readable medium encoded with instructions that, when executed in hardware, perform a process, the process comprising the method according to claim 1.
